(19) United States
(12) Patent Application Publication
(10) Pub. No.: US 2024/0046290 A1
(43) Pub. Date: Feb. 8, 2024

(54) RENDERING SURVEY RESPONSES AS PERSONAS

(71) Applicant: Qatar Foundation for Education, Science and Community Development, Doha (QA)

(72) Inventors: Soon-gyo Jung, Doha (QA); Jim Jansen, Doha (QA); Joni Salminem, Doha (QA); Hind Almerekhi, Doha (QA)

(21) Appl. No.: 18/230,322

(22) Filed: Aug. 4, 2023

Related U.S. Application Data
(60) Provisional application No. 63/395,204, filed on Aug. 4, 2022.

(51) Int. Cl. G06Q 30/0203; G06Q 30/0204

(52) U.S. Cl. CPC G06Q 30/0203; G06Q 30/0204

(57) ABSTRACT

Personas are rendered from survey results by receiving survey data; receiving, from a designer, prospective end-user demographic characteristics; identifying a name from a name database based on the prospective end-user demographic characteristics; identifying a picture from a picture database based on the prospective end-user demographic characteristics; generating a persona from the survey data, the persona including the name, the picture, a predefined number of agreed positions and disagreed positions selected from the survey data; and outputting the persona to the designer.

### CROSS REFERENCES TO RELATED APPLICATIONS

The present disclosure claims priority to U.S. Provisional Patent Application No.: 63/395,204 entitled “RENDERING SURVEY RESPONSES AS PERSONAS” and filed on Aug. 4, 2022, which is incorporated herein by reference in its entirety.

### TECHNICAL FIELD

The present disclosure relates to a software tools to improve human-computer interaction (HCI), and more particularly with reference to the analysis of data via human-centered computing.

### SUMMARY

The present disclosure provides new and innovative systems and methods for the analysis of data, particularly survey data, using design concepts from human-centered computing. As survey data are collected, designers may extract using personas for various data sets. Personas are fictitious people that represent real user groups, with the purpose of helping designers put themselves in the position of end-users of software systems, applications, and other tangible or intangible offerings provided to society at large. Personas are, thus, a tool of user-centered design and a research topic within human-computer interaction (HCI) and the broader field of user modeling. In competitive markets, it is important that products are human-centric, that is, that they solve real end-user needs and, therefore, deliver concrete value to end-users.

As used herein, in the context of data being analyzed from surveys, an end-user represents a respondent to the survey, whether real or hypothetical. Accordingly, a persona represents a hypothetical end-user. Similarly, designer refers to users of personas, which may be any stakeholder or interested party in the data, whether to analyze or make decisions in relation to end-users.

In various aspects, a method, a system for performing the method, and various goods produced by the method are provided. In various aspects, the method includes: receiving survey data; receiving, from a designer, prospective end-user demographic characteristics; identifying a name from a name database based on the prospective end-user demographic characteristics; identifying a picture from a picture database based on the prospective end-user demographic characteristics; generating a persona from the survey data, the persona including the name, the picture, a predefined number of agreed positions and disagreed positions selected from the survey data; and outputting the persona to the designer.

In various aspects, a method, a system for performing the method, and various goods produced by the method are provided. In various aspects, the method includes: receiving survey data; receiving, from a designer, a desired position on a topic covered in the survey data; generating a persona from the survey data, the persona including a predefined number of agreed positions and disagreed positions selected from the survey data that include the desired position, and demographic characteristics of end-users in the survey data who responded with the desired position; identifying a name from a name database based on the demographic characteristics; identifying a picture from a picture database based on the demographic characteristics; and outputting the persona with the name and the picture to the designer.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flowchart of an example method for rendering survey responses as personas, according to embodiments of the present disclosure.

FIG. 2 is a flowchart of an example method for rendering survey responses as personas, according to embodiments of the present disclosure.

FIG. 3 illustrates an example demographic profile as may be rendered, according to embodiments of the present disclosure.

FIG. 4 illustrates a computing device, according to embodiments of the present disclosure.

### DETAILED DESCRIPTION

The present disclosure provides systems and methods for generating personas to represent data in a human-centric way. The method allows designers to explore and understand data with greater empathy and control over the analysis. The designers may explore the data from a demographics-first perspective (e.g., to identify what positions on topics end-users of certain demographics hold) or an item-first perspective (e.g., to identify with end-users who hold a specified position on a topic). According, the present disclosure provides an interactive persona system that generates personas truly in real-time in contrast to previous approaches that have either generated the whole persona set before displaying that set to designers or have only partially generated the personas in real-time by retrieving only some persona information (e.g., quotes) in real-time based on designers' information needs.

Also, previous systems rely on clustering to generate a set of static personas that cannot be modified by the designer once the personas have been created, or the only way to do so is the repeat the whole generation process. In contrasts, the persona generation system described in the present disclosure provides a fast and responsive interface for designers to generate the personas based on specific demographics or survey items in the dataset, which addresses one of the perennial issues of persona generation—how many personas to generate. Because the personas generated using the present disclosure correspond directly to the designer's informational needs, the number always falls in within a user-friendly range while still being based on the personas' deviations from the average response behaviors in the data.

The operations of the present disclosure is based on the analogy between survey items and personas' quotes, as survey items typically contain a statement that an end-user responds to (e.g., “I like X”) by choosing an option on a Likert scale (typically, between “Strongly agree” and “Strongly disagree”). When constructing personas, the present disclosure uses these statements as quotes for the persona profile to convey the attitudes of the persona. Therefore, the group of respondents that is likely to agree with “I like X” will have this statement shown as its quote in the persona profile under “This persona agrees with” and the group that is likely to disagree with the statement will have the quote under its “This persona disagrees with” section.

The persona generator constructs the personas from survey data in real-time via outlier detection, which means that whatever demographic characteristic(s) or item(s) a designer is interested in, the persona generator begins by determining the mean scores of each demographic group in the sample and selecting those demographic groups that considerably deviate from the mean score of all demographic groups. The idea is that if a demographic group's mean score is higher than s standard deviations (σ) from the mean of the whole population included in the data set, that the demographic group has a tendency of agreeing with the statement more than other demographic groups. If the group's mean score for the statement is lower than s standard deviations from the mean of the whole population, then the group has a tendency of disagreeing with the statement (relative to other groups). Accordingly, differentiating statements and positions can be found in the data and used to identify meaningful differences between different subsets of the population of respondents.

In various embodiments, the parameter s is the number of standard deviations that the systems test to the mean (both for positive (+) and negative (−)). The possible values of s stem for common values in outlier detection literature (e.g., ranging from 1 to 3, with 0.5 increments (i.e., 1.0, 1.5, 2.0, 2.5, 3.0). For example, with s=3, 99.87% of normally distributed data are situated within the range of mean ±3σ.

The persona generator computes the deviations of each demographic for each statement item in the data set using the possible values (e.g., five Likert values) separately, and then counts the number of deviations (either positive or negative) that each demographic group has. In various embodiments, setting a universal value for s that can always be used for all datasets under analysis may not be appropriate, because this results in a high number of scenarios where the generated personas either have too many statements they agree and disagree with (typically when the σ value is on the low end due to high conformity in the dataset), or there are no personas at all (typically when the σ value is on the high end due to low conformity in the dataset). Similarly, picking a value from the midpoint for s also does not always produce personas that would have adequate information to include enough information to be useful to a designer but, not too much information to be overwhelming to a designer. These two extremes, may be dependent on the sophistication of the designer, the dataset being analyzed, and other factors, such that the value of s is left under the control of the designer to affect in real-time what the appropriate amount of information to return is by adjusting the value of s.

A persona with too much information is not unique enough and has too many statements for the designer to effectively make sense of In contrast, a persona with too little information presents the designer with nothing to learn about. Accordingly, the personal generator solves this problem by allowing the designer to define a range of statements that the personas include on output. In some embodiments, the designer may set an upper value and a lower value that each persona includes to that for example, each persona has at least x (e.g., 3) and at maximum y (e.g., 7) agree and disagree statements.

These agreed positions and disagreed positions selected from the survey data represent positions that the persona agrees with or disagrees with more than the average demographic group, and may be defining feature for the group that the persona represents, or a point of interest shared (in aggregate) by a demographically defined group.

Personas can be generated according to the present disclosure either by using demographic characteristics or using survey items as a starting point, which provides versatility in the process. For example, a scenario where demographic generation is appropriate could be a United Nations cross-country survey about social matters. An analyst (as a designer) might want to know what kind of answers young women in developing countries gave. To investigate this scenario, the analyst selects an age range and countries in for the persona generator to start with, and the persona generator generates one or more personas representing distinct response types from the corresponding demographics in the survey data.

In another example, the analyst might want to know what people in different countries think about a particular issue. In this scenario, the analyst uses the item-based persona generation to select an item of interest (e.g., “I like X”), and the persona generator generates personas that either agree or disagree with the item.

In another example, an analyst might want to know what persons in a given country think about a matter. In this scenario, the analyst first selects the item(s) of interest, and once various personas are output to the analyst, the analyst can then use filters using demographic characteristics to narrow down the personas to the given country of interest.

The output of the personas is kept clean to help designers focus on the essential information. The user interface to present the persona includes information corresponding to typical basic information in persona templates, such as age, gender, and education level. A name is obtained for the persona from a name database (e.g., using GAN2Name, a social media -based algorithm that outputs a person's likely name based on demographic characteristics) according to the demographic characteristics for the group that the persona represents. The picture is obtained for the persona from a picture database that contains demographically tagged facial images that are matched to the demographic characteristics for the group that the persona represents.

In various embodiments, the demographic characteristics for the persona are selected randomly from a range defined by the demographic characteristics of the group that the persona is to represent. For example, for a group of end-user respondents in a given group having an age range between 25-34 years of age, the persona may be assigned an age using a random value (e.g., 26), rather than outputting a range for the persona's age or an average value (weighted or unweighted) value for the demographic characteristic.

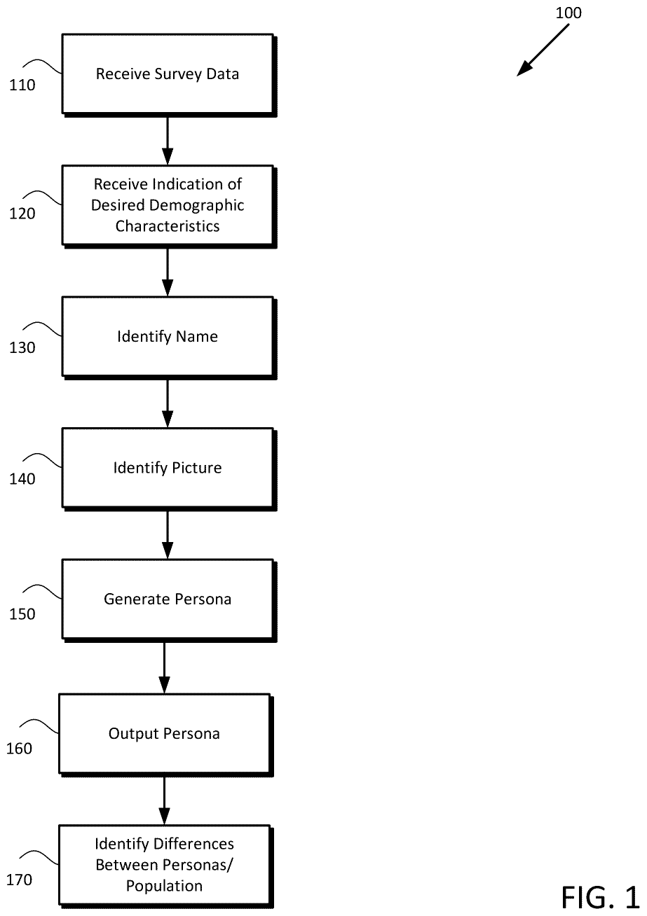

FIG. 1 is a flowchart of an example method 100 for rendering survey responses as personas, according to embodiments of the present disclosure.

At block 110, the system performing method 100 receives or accesses survey data gathered from a population of respondents. In various embodiments, the survey data includes various questions, corresponding answers to the questions, and demographic data related to the respondent who submitted a given set of responses. These demographic data may include an age or age range; a gender; a nationality; an ethnicity; a religion; an education level; an income level; a marital status; a working status and other demographic data used to differentiate or group individuals in a population. Additionally, various survey responses for actions taken within a time period may be used as demographic data (e.g., respondents who reported maintaining a given diet, partaking in various substances, using a given technology, making a given purchase, etc.).

The responses may include answers in various formats including yes/no, full text, Likert scale responses, coordinate-based responses (e.g., locations on a map, an image, or the like), etc.

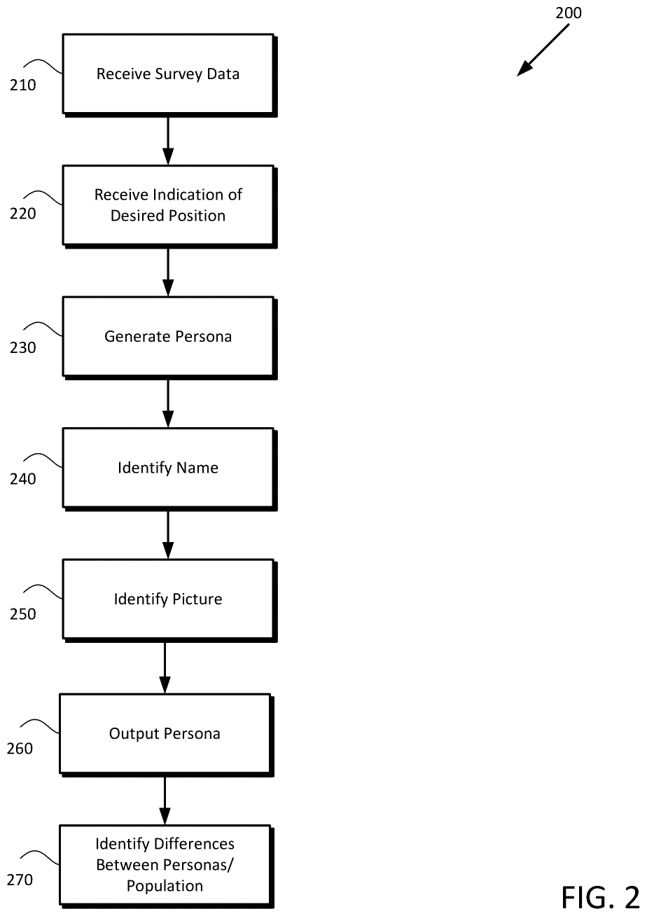

In various embodiments, the survey data are received from a larger set of survey data, which have been filtered to exclude responses from respondents that have undesired demographic characteristics or positions. Accordingly, block 110 of method 100 may be performed after block 120 or block 220 of method 200 discussed in relation to FIG. 2 to reduce the size of the dataset, thereby improving the speed at which the system can process the request for persona generation, and reducing the computing resources used to perform method 100.

At block 120, the system receives an indication of desired demographic characteristics to use when generating a persona. For example, a designer may specify one, two, three, etc. different demographic characteristics that the persona should have.

At block 130, the system identifies a name from a name database based on the desired demographic characteristics to use for the persona. In various embodiments, the desired demographic characteristics are used to filter the available names or to weight a probabilistic choice of a name from the name database.

For example, if the desired demographic characteristics include gender, the name selected may be limited to names associated with the selected gender. In another example, if the desired demographic characteristics do not include gender, the gender divide in the remaining subset of the population that does have the other demographic characteristics may be used to select the name. Accordingly, if the subset of the population who has reported previously attending a single-gender exercise class has a gender divide of N % women and (100−N)% men, the system may set a weight to select a feminine name N % of the time.

In another example, if the desired demographic characteristics includes an age range, the system may weight the selection of the name to select names more closely associated with persons in the desired age range than persons outside of the age range. For example, the use of diminutives with children rather than adults, names that have changed in popularity over time, etc.

At block 140, the system identifies a picture from a picture database based on the desired demographic characteristics to use for the persona. In various embodiments, the desired demographic characteristics are used to filter the available pictures or to weight a probabilistic choice of a picture from the picture database. For example, if the desired demographic characteristics include gender, the picture selected may be limited to pictures associated with the selected gender. In another example, if the desired demographic characteristics do not include gender, the gender divide in the remaining subset of the population that does have the other demographic characteristics may be used to select the picture. Accordingly, if the subset of the population who has reported previously attending a single-gender exercise class has a gender divide of N % women and (100−N)% men, the system may set a weight to select a feminine picture N % of the time.

In various embodiments, to ensure consistency between the selections of the name and the picture, the system may perform block 130 and block 140 in parallel or make the selection in only one of block 130 and block 140. Accordingly, names and pictures associated with a shared set of demographic characteristics should be selected (e.g., masculine/feminine pairings of names and pictures, ethnically consistent names and pictures, etc.).

At block 150, the system generates a persona from the survey data. The persona includes the name, the picture, and a predefined number of agreed positions and disagreed positions selected from the survey data associated with those respondents of the population of respondents having at least one reported demographic characteristic matching the desired demographic characteristics.

In various embodiments, the system generates the persona via clustering, such that the system identifies a cluster of respondents from the data set and the persona represents one cluster of respondents identified in the survey data. The persona represents a given cluster of respondents by being associated with a mean, median, or mode value for the individual members of the cluster, or a specific value thereof selected based on statistical weighting. For example, a cluster having respondents in an age range of 20-40 years of age may be represented by the average age of all respondents therein, the most frequently reported age therein, a randomly selected age between 20-40 years of age, a weighted probabilistic selection of an age between 20-40 years of age, etc.

In various embodiments, the system generates the persona via statistical heuristics, so that the persona represents an outlier position on a survey response from the survey data relative to a median response value for the population of respondents. By using statistical heuristics rather than clustering operations, the system may conserve computing resources, while still providing equivalently representative personas to developers. By identifying outlier positions for the subset of respondents having the desired demographic characteristics, the system is further able to report more useful data about persons belonging to the demographic group under consideration.

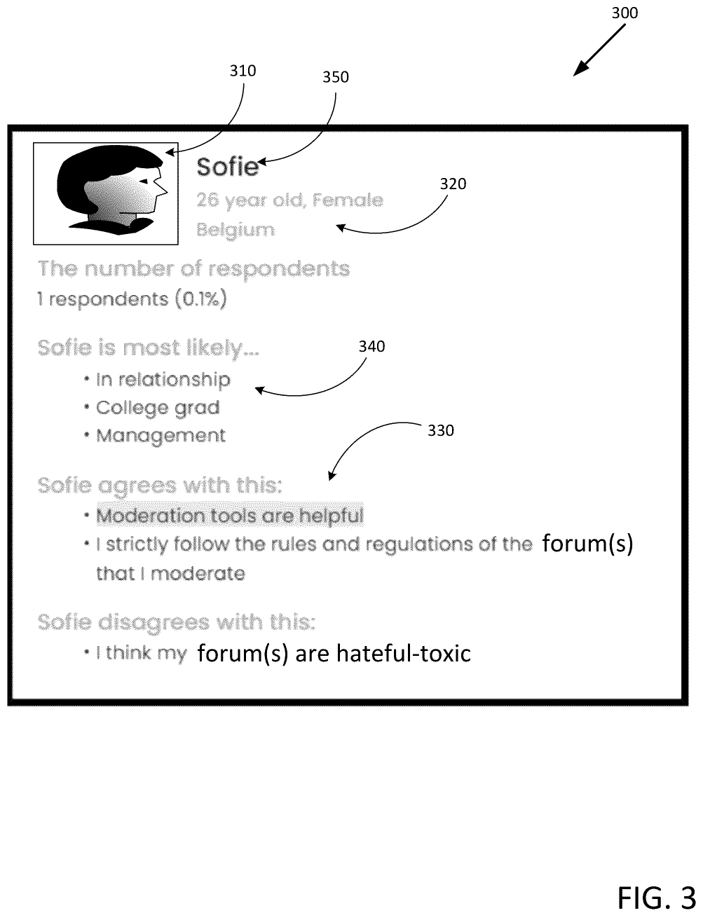

At block 160, the system outputs the persons to the designer. The persona presents a demographic profile, as discussed in greater detail with respect to FIG. 3, which represents a hypothetical person (also referred to as a “persona”) having certain demographic characteristics or positions shared with a subset of a population of respondents to the questions.

At block 170, the system identifies differences between two or more personas (e.g., generated according to method 100 or method 200) and/or the population of respondents as a whole. These differences can include differences in respective demographic characteristics in a first persona compared to the associated demographic characteristics in a second persona.

FIG. 2 is a flowchart of an example method 200 for rendering survey responses as personas, according to embodiments of the present disclosure.

At block 210, the system performing method 100 receives or accesses survey data gathered from a population of respondents. In various embodiments, the survey data includes various questions, corresponding answers to the questions, and demographic data related to the respondent who submitted a given set of responses. These demographic data may include an age or age range; a gender; a nationality; an ethnicity; a religion; an education level; an income level; a marital status; a working status and other demographic data used to differentiate or group individuals in a population. Additionally, various survey responses for actions taken within a time period may be used as demographic data (e.g., respondents who reported maintaining a given diet, partaking in various substances, using a given technology, making a given purchase, etc.).

The responses may include answers in various formats including yes/no, full text, Likert scale responses, coordinate-based responses (e.g., locations on a map, an image, or the like), etc.

In various embodiments, the survey data are received from a larger set of survey data, which have been filtered to exclude responses from respondents that have undesired demographic characteristics or positions. Accordingly, block 210 of method 200 may be performed after block 220 or block 120 of method 100 discussed in relation to FIG. 1 to reduce the size of the dataset, thereby improving the speed at which the system can process the request for persona generation, and reducing the computing resources used to perform method 200.

At block 220, the system receives an indication of desired position to use when generating a persona. For example, a designer may specify that persona should agree or disagree with a given statement (e.g., “I agree that speaking in public is difficult”, “I disagree that speaking in public is easy”, “I agree that pudding is distasteful”, “I disagree that pudding is delicious”, etc.), or have a given non-binary position on a topic (e.g., “I strongly agree [on a 1-5 Likert scale] that public speaking is nerve wracking”, “I believe that option C provides the strongest solution to the problem”, etc.).

At block 230, the system generates a persona from the survey data. The persona includes the desired positions, and the system identifies a set of demographic characteristics associated with persons having the desired positions. These demographic characteristics are then used to identify other positions, up to a predefined number of agreed positions and disagreed positions, selected from the survey data associated with those respondents of the population of respondents having at least one reported demographic characteristic matching the identified demographic characteristics for respondents holding the desired positions.

In various embodiments, the system generates the persona via clustering, such that the system identifies a cluster of respondents from the data set and the persona represents one cluster of respondents identified in the survey data. The persona represents a given cluster of respondents by being associated with a mean, median, or mode value for the individual members of the cluster, or a specific value thereof selected based on statistical weighting. For example, a cluster having respondents in an age range of 20-40 years of age may be represented by the average age of all respondents therein, the most frequently reported age therein, a randomly selected age between 20-40 years of age, a weighted probabilistic selection of an age between 20-40 years of age, etc.

In various embodiments, the system generates the persona via statistical heuristics, so that the persona represents an outlier position on a survey response from the survey data relative to a median response value for the population of respondents. By using statistical heuristics rather than clustering operations, the system may conserve computing resources, while still providing equivalently representative personas to developers. By identifying outlier positions for the subset of respondents having the desired demographic characteristics, the system is further able to report more useful data about persons belonging to the demographic group under consideration.

At block 240, the system identifies a name from a name database based on the desired demographic characteristics to use for the persona. In various embodiments, the desired demographic characteristics are used to filter the available names or to weight a probabilistic choice of a name from the name database.

For example, if the desired demographic characteristics include gender, the name selected may be limited to names associated with the selected gender. In another example, if the desired demographic characteristics do not include gender, the gender divide in the remaining subset of the population that does have the other demographic characteristics may be used to select the name. Accordingly, if the subset of the population who has reported previously attending a single-gender exercise class has a gender divide of N % women and (100−N)% men, the system may set a weight to select a feminine name N % of the time.

In another example, if the desired demographic characteristics includes an age range, the system may weight the selection of the name to select names more closely associated with persons in the desired age range than persons outside of the age range. For example, the use of diminutives with children rather than adults, names that have changed in popularity over time, etc.

At block 250, the system identifies a picture from a picture database based on the desired demographic characteristics to use for the persona. In various embodiments, the desired demographic characteristics are used to filter the available pictures or to weight a probabilistic choice of a picture from the picture database. For example, if the desired demographic characteristics include gender, the picture selected may be limited to pictures associated with the selected gender. In another example, if the desired demographic characteristics do not include gender, the gender divide in the remaining subset of the population that does have the other demographic characteristics may be used to select the picture. Accordingly, if the subset of the population who has reported previously attending a single-gender exercise class has a gender divide of N % women and (100−N)% men, the system may set a weight to select a feminine picture N % of the time.

In various embodiments, to ensure consistency between the selections of the name and the picture, the system may perform block 240 and block 250 in parallel or make the selection in only one of block 240 and block 250. Accordingly, names and pictures associated with a shared set of demographic characteristics should be selected (e.g., masculine/feminine pairings of names and pictures, ethnically consistent names and pictures, etc.).

At block 260, the system outputs the persons to the designer. The persona presents a demographic profile, as discussed in greater detail with respect to FIG. 3, which represents a hypothetical person (also referred to as a “persona”) having certain demographic characteristics or positions shared with a subset of a population of respondents to the questions.

At block 270, the system identifies differences between two or more personas (e.g., generated according to method 100 or method 200) and/or the population of respondents as a whole. These differences can include differences the agreed positions and disagreed positions in a first persona compared to the agreed positions and disagreed positions in a second persona.

FIG. 3 illustrates an example demographic profile 300 as may be rendered, according to embodiments of the present disclosure. A demographic profile represents a hypothetical person (also referred to as a “persona”) that has certain positions, demographics, or other features in common with respondents to survey data, and provides a humanizing output for the statistical analyses of the survey data.

The demographic profile 300 includes a photo or other image 310 selected from a photo or image database that includes various images or photographs that are tagged with various demographic characteristics. These tags allow the system to identify an image having one or more demographic characteristics matching a desired characteristic set for the demographic profile 300. For example, if the demographic profile 300 is generated to represent a woman between twenty and thirty years of age, living in Belgium, the system may ignore images in the database that do not have associated tags with the desired characteristics, and select one image from among the remaining images to represent the profile. Continuing the example, if the photo database includes at least two images of women between twenty and thirty years of age living in Belgium, that each include additional tags that are not indicated as desired/undesired, the system may ignore these non-indicated characteristics when defining a pool of images to select between to represent the profile.

The demographic profile 300 includes demographic characteristics 320 for the hypothetical person represented in the demographic profile 300. In some embodiments, these demographic characteristics can be desired characteristics set by a user of developer to constrain the dataset to the respondents from the general population to a more specific sub-set of respondents. In some embodiments, the demographic characteristics 320 are selected based on other constraints set by a developer or user for the hypothetical person. These demographic characteristics can include, but are not limited to, one or more, two or more, three or more, etc. of an age range; a gender; a nationality; an ethnicity; a religion; an education level; an income level; a marital status; a working status, or the like that are used to demographically identify different persons. In various embodiments, when the demographic data include multiple options (e.g., various ages in an age range), the system can randomly (with or without weighting) select a single value for that characteristics.

The demographic profile 300 includes a predefined number of positions 330 that the hypothetical person agrees with or disagrees with, based on the survey data. The positions may represent various responses (or groupings of responses) that respondents to a survey submitted in reply to one or more survey questions. In various embodiments, these positions include reformatted versions of the survey questions (e.g., posed as statements) that include the response in how the statement is formulated. For example, the position of “I agree that moderation tools are helpful” may include the question of “Do you think that moderation tools are helpful” (and variations thereof) that respondents replied positively to (e.g., “yes”, “true”, 4/5 or 5/5 on a Likert scale, etc.). In various embodiments, in addition to or alternatively to using desired characteristics as a basis for generating a profile, a developer or user of the dataset may specify various desired positons that the hypothetical person represented by the demographic profile 300 should have.

In various embodiments, the positions represent outlier opinions compared to the average user of the population. Stated differently, the positions are selected to provide differentiating details for the hypothetical person compared to the “average” respondent. For example, if a predefined number of positions 330 are to be reported, the system may avoid reporting positions that most of the respondents share in favor or positions that a more uniquely held by persons having the specified demographics for the hypothetical persons. Accordingly, the example position of “I agree that water is wet” may be held by all of the respondents in the population, but the position of “I agree that moderation tools are helpful” may be a minority position in the general population of survey respondents, but a majority position among respondents who are of a certain gender and within a certain age range, and is therefore included in the demographic profile 300 of a hypothetical person of that gender and age range.

The demographic profile 300 includes sociographic data 340 for the hypothetical person represented in the demographic profile 300. These resultant data 340 represent the most frequent, average (mean, median, or mode), or a randomly selected value from the respondent data to represent the hypothetical person consistently with the selected desired demographic characteristics 320 or positions 330. For example, out of the sub-set of respondents who are women between woman between twenty and thirty years of age, living in Belgium and agree with the statements that “moderation tools are helpful”, the system may identify that such respondents certain similarities in other demographic characteristics (e.g., most are college graduations) or positions (e.g., most agree with the statement “I strictly follow the rules and regulations of the forum(s) that I moderate” and disagree with the statement that “I think my forum(s) are hateful-toxic”).

The demographic profile 300 includes a name 350 for the hypothetical person represented in the demographic profile 300. In various embodiments, the name 350 may be considered to be a special case of sociographic data 340, as the system uses the demographic data already associated with the hypothetical person (either the desired demographics or resultant demographics) to select an appropriate name from a name database. For example, if the hypothetical person is a woman, a set of female names is queried for the name 350 to use in the demographic profile 300 (e.g., excluding the male names from consideration). In another example, if the hypothetical person is Belgian, the system may prioritize names that are more commonly used in Belgium than in other countries, but may still consider (albeit at a lower probabilistic weight) the less common names found in Belgium, but may set a floor for consideration so that names below a given rarity are not considered. In another example, if the hypothetical person is Belgian, but is noted via demographic, sociographic, or position data to be an immigrant, the system may prioritize using less common names from the name set or select a different name set (e.g., associated with the country of emigration).

Other metrics may also be provided in the demographic profile as selected by a developer. For example, the number of respondents from the dataset that match the desired demographics/responses can be indicated to the user.

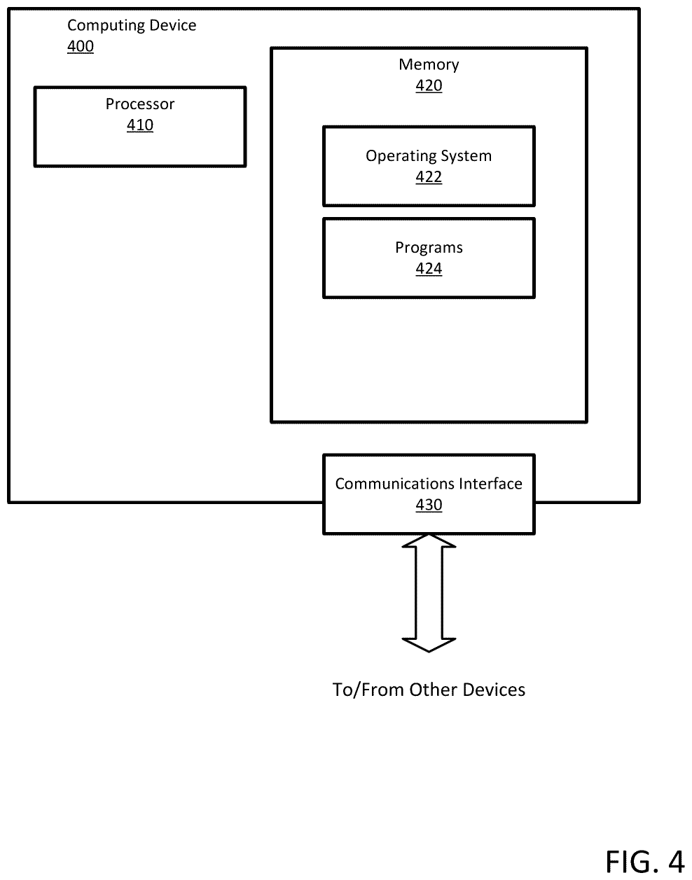

FIG. 4 illustrates a computing device 400, as may be used to perform method 100, method 200, and combinations thereof, according to embodiments of the present disclosure. The computing device 400 may include at least one processor 410, a memory 420, and a communication interface 430.

The processor 410 may be any processing unit capable of performing the operations and procedures described in the present disclosure. In various embodiments, the processor 410 can represent a single processor, multiple processors, a processor with multiple cores, and combinations thereof.

The memory 420 is an apparatus that may be either volatile or non-volatile memory and may include RAM, flash, cache, disk drives, and other computer readable memory storage devices. Although shown as a single entity, the memory 420 may be divided into different memory storage elements such as RAM and one or more hard disk drives. As used herein, the memory 420 is an example of a device that includes computer-readable storage media, and is not to be interpreted as transmission media or signals per se.

As shown, the memory 420 includes various instructions that are executable by the processor 410 to provide an operating system 422 to manage various features of the computing device 400 and one or more programs 424 to provide various functionalities to users of the computing device 400, which include one or more of the features and functionalities described in the present disclosure. One of ordinary skill in the relevant art will recognize that different approaches can be taken in selecting or designing a program 424 to perform the operations described herein, including choice of programming language, the operating system 422 used by the system 400, and the architecture of the processor 410 and memory 420. Accordingly, the person of ordinary skill in the relevant art will be able to select or design an appropriate program 424 based on the details provided in the present disclosure.

The communication interface 430 facilitates communications between the computing device 400 and other devices, which may also be computing devices as described in relation to FIG. 4. In various embodiments, the communication interface 430 includes antennas for wireless communications and various wired communication ports. The computing device 400 may also include or be in communication, via the communication interface 430, one or more input devices (e.g., a keyboard, mouse, pen, touch input device, etc.) and one or more output devices (e.g., a display, speakers, a printer, etc.).

Although not explicitly shown in FIG. 4, it should be recognized that the computing device 400 may be connected to one or more public and/or private networks via appropriate network connections via the communication interface 430. It will also be recognized that software instructions may also be loaded into the non-transitory computer readable medium 420 from an appropriate storage medium or via wired or wireless means.

Accordingly, the computing device 400 is an example of a system that includes a processor 410 and a memory 420 that includes instructions that (when executed by the processor 410) perform various embodiments of the present disclosure. Similarly, the memory 420 is an apparatus that includes instructions that when executed by a processor 410 perform various embodiments of the present disclosure.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

What is claimed is:

1. A method, comprising:
receiving survey data gathered from a population of respondents;
receiving, from a designer, an indication of desired demographic characteristics for a persona;
identifying a name from a name database based on the desired demographic characteristics;
identifying a picture from a picture database based on the desired demographic characteristics;
generating a persona from the survey data, the persona including the name, the picture, and a predefined number of agreed positions and disagreed positions selected from the survey data associated with those respondents of the population of respondents having at least one reported demographic characteristic matching the desired demographic characteristics; and
outputting the persona to the designer.

2. The method of claim 1, wherein the received survey data are pre-filtered from a larger set of survey data to exclude responses from respondents that have undesired demographic characteristics.

3. The method of claim 1, wherein the survey data include responses on a Likert scale.

4. The method of claim 1, wherein the persona is generated via statistical heuristics, wherein the persona represents an outlier position on a survey response from the survey data relative to a median response value for the population of respondents.

5. The method of claim 1, wherein the persona is generated via clustering, wherein the persona represents one cluster of respondents identified in the survey data.

6. The method of claim 1, wherein the desired demographic characteristics include values selected for two or more characteristics of:
an age range;
a gender;
a nationality;
an ethnicity;
a religion;
an education level;
an income level;
a marital status; and
a working status.

7. A method, comprising:
receiving survey data gathered from a population of respondents;
receiving, from a designer, an indication of a desired position on a topic covered in the survey data;
generating a persona from the survey data, the persona including a predefined number of agreed positions and disagreed positions selected from the survey data that include the desired position, and demographic characteristics of respondents from the population who responded with the desired position;
identifying a name from a name database based on the demographic characteristics;
identifying a picture from a picture database based on the demographic characteristics; and
outputting the persona with the name and the picture to the designer.

8. The method of claim 7, wherein the received survey data are pre-filtered from a larger set of survey data to exclude responses from respondents that have undesired demographic characteristics.

9. The method of claim 7, wherein the survey data include responses on a Likert scale.

10. The method of claim 7, wherein the persona is generated via statistical heuristics, wherein the persona represents an outlier position on a survey response from the survey data relative to a median response value for the population of respondents.

11. The method of claim 7, wherein the persona is generated via clustering, wherein the persona represents one cluster of respondents identified in the survey data.

12. The method of claim 7, wherein the demographic characteristics include two or more characteristics of:
an age range;
a gender;
a nationality;
an ethnicity;
a religion;
an education level;
an income level;
a marital status; and
a working status.

13. A system, comprising:
a processor; and
a memory including instructions that when executed by the processor perform operations including:
receiving survey data gathered from a population of respondents;
receiving, from a designer, an indication of desired demographic characteristics for a persona;
identifying a name from a name database based on the desired demographic characteristics;
identifying a picture from a picture database based on the desired demographic characteristics;
generating a persona from the survey data, the persona including the name, the picture, and a predefined number of agreed positions and disagreed positions selected from the survey data associated with those respondents of the population of respondents having at least one reported demographic characteristic matching the desired demographic characteristics; and
outputting the persona to the designer.

14. The system of claim 13, wherein the operations further include:
receiving, from the designer, a desired position on a topic covered in the survey data;
generating a second persona from the survey data, the second persona including the predefined number of agreed positions and disagreed positions selected from the survey data that include the desired position, and associated demographic characteristics of respondents who responded with the desired position;
identifying a second name from the name database based on the associated demographic characteristics;
identifying a second picture from the picture database based on the associated demographic characteristics; and
outputting the second persona with the second name and the second picture to the designer.

15. The system of claim 14, wherein the operations further comprise:
identifying differences in between the demographic characteristics in the persona compared to the associated demographic characteristics in the second persona; or
identifying differences in between the agreed positions and disagreed positions in the persona compared to the agreed positions and disagreed positions in the second persona.

16. The system of claim 13, wherein the received survey data are pre-filtered from a larger set of survey data to exclude responses from respondents that have undesired demographic characteristics.

17. The system of claim 13, wherein the survey data include responses on a Likert scale.

18. The system of claim 13, wherein the persona is generated via statistical heuristics, wherein the persona represents an outlier position on a survey response from the survey data relative to a median response value for the population of respondents.

19. The system of claim 13, wherein the persona is generated via clustering, wherein the persona represents one cluster of respondents identified in the survey data.

20. The system of claim 13, wherein the desired demographic characteristics include two or more characteristics of:
an age range;
a gender;
a nationality;
an ethnicity;
a religion;
an education level;
an income level;
a marital status; and
a working status.
